(19) United States
(12) Patent Application Publication
(10) Pub. No.: US 2026/0356114 A1
(43) Pub. Date: Nov. 12, 2026

(54) PRINTING SYSTEM AND MEASUREMENT METHOD

(71) Applicant: Dover Europe Sàrl, Vernier (CH)

(72) Inventor: Biser Ivanov, Nottingham (GB)

(21) Appl. No.: 19/644,710

(22) Filed: Apr. 10, 2026

(30) Foreign Application Priority Data
Apr. 11, 2025 (GB) 2505493.3

(51) Int. Cl. B41J 31/16; B41J 2/325; G01S 7/527; G01S 7/53; G01S 15/10; G01S 15/88

(52) U.S. Cl. CPC B41J 31/16; B41J 2/325; G01S 7/527; G01S 7/53; G01S 15/101; G01S 15/88

(57) ABSTRACT

A printing system including one or more ultrasonic transmitters to transmit an ultrasound signal towards a component of the printing system, an ultrasonic receiver to receive an echo signal reflected from the component, and a processor to fit a part of a sinusoidal wave, from a minimum to a maximum of the sinusoidal wave, to a front of an upper envelope of the echo signal and/or fit a part of a sinusoidal wave, from a maximum to a minimum of the sinusoidal wave, to a front of a lower envelope of the echo signal, determine a time-of-arrival corresponding to the minimum of the sinusoidal wave fitted to the upper envelope and/or the maximum of the sinusoidal wave fitted to the lower envelope, and calculate the distance between the ultrasonic receiver and the component, based on a time-of-flight of the ultrasound signal and the speed of the ultrasound signal.

### CLAIM OF PRIORITY

This application claims priority to GB Patent Application Serial No. 2505493.3, filed on Apr. 11, 2025, the entire contents of which are hereby incorporated by reference.

### FIELD

The specification relates to a method of calculating the distance between a receiver and a target, and a printing system.

### BACKGROUND

Transfer printing is well known in the art of commercial printing. Typically, a thermal printing apparatus includes a pair of spools onto which tape (also known as ribbon) is wound. The ribbon is a long strip of material carrying ink, typically on one side. The ribbon extends between the spools (and usually passes around one or more guide members). The ribbon is transferred along a ribbon path from a supply spool, to a take up spool, past a printhead which is operable to transfer ink from the ribbon to a substrate. One or both of the supply spool and the take up spool are typically driven in order to transfer the ribbon between the spools, past the printhead. The printhead may include thermally energisable printing elements or pixels, which are operable to warm the ink on the ribbon such that it can be removed from the ribbon and transferred to the substrate to form an image, for example data, a pattern, a bar code, QR code, etc.

Before printing using the thermal transfer printer, a calibration process is typically performed. The calibration process may involve many different sub-processes. An example of the sub-processes that could be performed during the calibration process is as follows:
1. tension calibration;
2. measure ribbon diameters;
3. thermal print head (TPH) calibration;
4. carriage calibration.

The calibration process may include some or all of the above sub-processes, or the calibration process may include different sub-processes to those listed above. The above sub-processes may have a different order of execution to the above list.

Typically, the “measure ribbon diameters” sub-process is time consuming. Therefore, the time taken for the overall calibration process is greatly affected by the length of this process. With specific reference to measuring ribbon diameters, existing printing apparatuses rely on using tension and movement rollers and from these indirectly calculate the diameter of the ribbons. An improvement in the speed of measuring the ribbon diameters would have a big impact on the overall speed of the calibration process, from the point when the user closes the cassette to the point when the printer can make the first print, since measuring the ribbon diameters is currently one of the slowest stages of the calibration process.

Therefore, there is a need for an improved method for measuring ribbon diameters, so that the calibration of thermal transfer printers can be made more efficient.

It is important that the ribbon diameter of printing apparatuses is measured with high accuracy during the calibration process. For example, the diameter of the ribbons should typically be measured with an accuracy of less than 0.5 mm.

Currently, various methods can be used to measure distance, such as the tension and movement rollers mentioned above. It is also known to use ultrasound waves to measure distance, using a time-of-flight calculation. However, the known methods of measuring distance with ultrasound waves are relatively inaccurate, and are therefore not typically suitable for use in thermal transfer printers.

Typically, an echo time-of-flight calculation is made by receiving and detecting an ultrasound wave that has been reflected from a target surface (i.e. detecting an echo signal). The distance of the target surface from the receiver is calculated based on the speed of sound and the time at which the reflected echo signal is detected. In order to determine the time at which the reflected echo signal is detected, the signal is typically amplified, and a voltage threshold is applied. The first part of the signal to exceed the threshold value is taken, in order to determine the time at which the reflected echo signal is received.

For example, FIG. 1 depicts an existing method of measuring distance using ultrasound waves. FIG. 1 shows a signal 100 of an ultrasound wave that has been reflected from a target surface. The signal to the left of time marker 101 is a noise and ringing signal 110. The signal to the right of time marker 101 is a reflected echo signal 120. The time marker 101 therefore illustrates the time at which the echo signal 120 first reaches the receiver. At this point, the ringing signal 110 and the echo signal 120 will overlap. The dotted lines 111 and 121 in FIG. 1 show the overlapping portions of the ringing signal 110 and the echo signal 120. These overlapping portions interfere to form the solid line making up an interference signal 100 in FIG. 1, around the time marker 101. Therefore, it is not possible to accurately determine the time of the time marker 101, when the echo signal 120 is received, because the noise and the ringing signal 110 interfering with the reflected echo signal 120 make it difficult to identify the point at which the echo signal 120 is first received. The interference signal 100 at the time marker 101 is typically less than the minimum possible voltage threshold, and therefore cannot be detected. The time at which the echo signal 120 first reaches the receiver can therefore only be inaccurately calculated using the existing method. This leads to inaccuracies in the distance calculated, when the time-of-flight is used to determine the distance. Therefore, when measuring distance using ultrasound waves, it is not typically possible to calculate a distance to a high degree of accuracy.

For this reason, it is typically not appropriate to use ultrasound waves to measure the ribbon diameters during a transfer printer calibration process, because of the inaccuracy of known techniques using ultrasound and the high accuracy that is required during printer calibration.

Therefore, there is a need for an improved method of measuring distance, with improved accuracy. While the above description relates to measuring the ribbon diameters during the calibration of printing apparatuses, it will be appreciated that high accuracy distance measurements would be advantageous for a number of different uses.

### BRIEF DESCRIPTION

There is provided a printing system comprising a printing apparatus; one or more ultrasonic transmitters configured to transmit an ultrasound signal towards a component of the printing system; an ultrasonic receiver configured to receive an echo signal corresponding to the ultrasound signal reflected from the component; and a processor configured to: fit a part of a sinusoidal wave, from a minimum to a maximum of the sinusoidal wave, to a front of an upper envelope of the echo signal and/or fit a part of a sinusoidal wave, from a maximum to a minimum of the sinusoidal wave, to a front of a lower envelope of the echo signal; determine a time-of-arrival corresponding to the minimum of the sinusoidal wave fitted to the upper envelope and/or the maximum of the sinusoidal wave fitted to the lower envelope; determine a time-of-flight of the ultrasound signal; and calculate the distance between the ultrasonic receiver and the component, based on the time-of-flight and the speed of the ultrasound signal.

The printing apparatus may comprise the processor.

The printing apparatus may comprise an ultrasonic transceiver configured to both transmit and receive the ultrasound signal.

The component may be a ribbon positioned on a spool support of the printing apparatus.

At least one ultrasonic transmitter may be configured to transmit an ultrasound signal towards a supply spool support of the printing apparatus, and the processor may be configured to calculate the diameter or radius of a supply spool of ribbon.

At least one ultrasonic transmitter may be configured to transmit an ultrasound signal towards a take up spool support of the printing apparatus, and the processor may be configured to calculate the diameter or radius of a take up spool of ribbon.

The processor may be configured to fit the sinusoidal wave to the echo signal by adjusting one or more of the amplitude and frequency of the sinusoidal wave; and/or translation of the sinusoidal wave.

The processor may be configured to fit the sinusoidal wave to the echo signal by aligning the maximum of the sinusoidal wave with a maximum of the upper envelope of the echo signal and/or aligning the minimum of the sinusoidal wave with a minimum of the lower envelope of the echo signal.

The processor may be configured to fit the sinusoidal wave to the echo signal by adjusting the amplitude of the sinusoidal wave so that the minimum of the sinusoidal wave fitted to the upper envelope and/or the maximum of the sinusoidal wave fitted to the lower envelope aligns with a vertical midpoint of the echo signal.

The processor may be configured to fit the sinusoidal wave to the echo signal by adjusting the frequency of the sinusoidal wave so that the shape of the sinusoidal wave closely fits the shape of the front of the upper and/or lower envelope of the echo signal.

The processor may be configured to fit the sinusoidal wave to the echo signal in a plurality of iterations.

The processor may be configured to measure a degree of similarity between the shape of the sinusoidal wave and the shape of the upper envelope and/or lower envelope of the echo signal.

There is also provided a method of calculating the distance between an ultrasound receiver and a component of a printing system, comprising:
receiving an echo signal corresponding to an ultrasound signal reflected from the component and received by the receiver;
fitting a part of a sinusoidal wave, from a minimum to a maximum of the sinusoidal wave, to a front of an upper envelope of the echo signal and/or fitting a part of a sinusoidal wave, from a maximum to a minimum of the sinusoidal wave, to a front of a lower envelope of the echo signal;
determining a time-of-arrival corresponding to the minimum of the sinusoidal wave fitted to the upper envelope and/or the maximum of the sinusoidal wave fitted to the lower envelope;
determining a time-of-flight of the ultrasound signal; and
calculating the distance between the receiver and the component, based on the time-of-flight and the speed of the ultrasound signal.

The method may further comprise the step of transmitting the ultrasound signal towards the component using an ultrasonic transmitter.

The method may further comprise the step of receiving the echo signal using an ultrasonic receiver.

The ultrasonic transmitter and/or the ultrasonic receiver may be an ultrasonic transceiver.

The step of fitting the sinusoidal wave may comprise adjusting one or more of the amplitude and frequency of the sinusoidal wave; and/or translation of the sinusoidal wave.

The step of fitting the sinusoidal wave may comprise aligning the maximum of the sinusoidal wave with a maximum of the upper envelope of the echo signal and/or aligning the minimum of the sinusoidal wave with a minimum of the lower envelope of the echo signal.

The step of fitting the sinusoidal wave may comprise adjusting the amplitude of the sinusoidal wave so that the minimum of the sinusoidal wave fitted to the upper envelope and/or the maximum of the sinusoidal wave fitted to the lower envelope aligns with a vertical midpoint of the echo signal.

The step of fitting the sinusoidal wave may comprise adjusting the frequency of the sinusoidal wave so that the shape of the sinusoidal wave closely fits the shape of the front of the upper and/or lower envelope of the echo signal.

The sinusoidal wave may be fitted to the echo signal in a plurality of iterations.

The method may further comprise measuring a degree of similarity between the shape of the sinusoidal wave and the shape of the front of the upper envelope and/or lower envelope of the echo signal.

The component may be a ribbon.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a signal of a reflected ultrasound wave, which can be analysed using various methods;

FIG. 2A is a sine wave, from -180 degrees to 180 degrees;

FIG. 2B is the sine wave of FIG. 2A, with increased amplitude and increased frequency;

FIG. 2C is the sine wave of FIG. 2A, with decreased amplitude and decreased frequency;

FIG. 3A is a sine wave fitted to the front of the upper envelope of a reflected ultrasound wave;

FIG. 3B is a sine wave fitted to the front of the upper envelope of a reflected ultrasound wave;

FIG. 3C is a sine wave fitted to the front of the upper envelope of a reflected ultrasound wave;

FIG. 3D is a sine wave fitted to the front of the upper envelope of a reflected ultrasound wave;

FIG. 4A is a signal of a reflected ultrasound wave, where the ultrasound wave has been reflected from a first object at a distance of 30mm from an ultrasonic transceiver;

FIG. 4B is a signal of a reflected ultrasound wave, where the ultrasound wave has been reflected from a second object at a distance of 30mm from an ultrasonic transceiver;

FIG. 5 is the signals of FIGS. 4A and FIG. 4B, superimposed onto one another, with a sine wave fitted to the front of the upper envelope of each signal; and

FIG. 6 is a front view of a printing apparatus.

### DETAILED DESCRIPTION OF THE DISCLOSURE

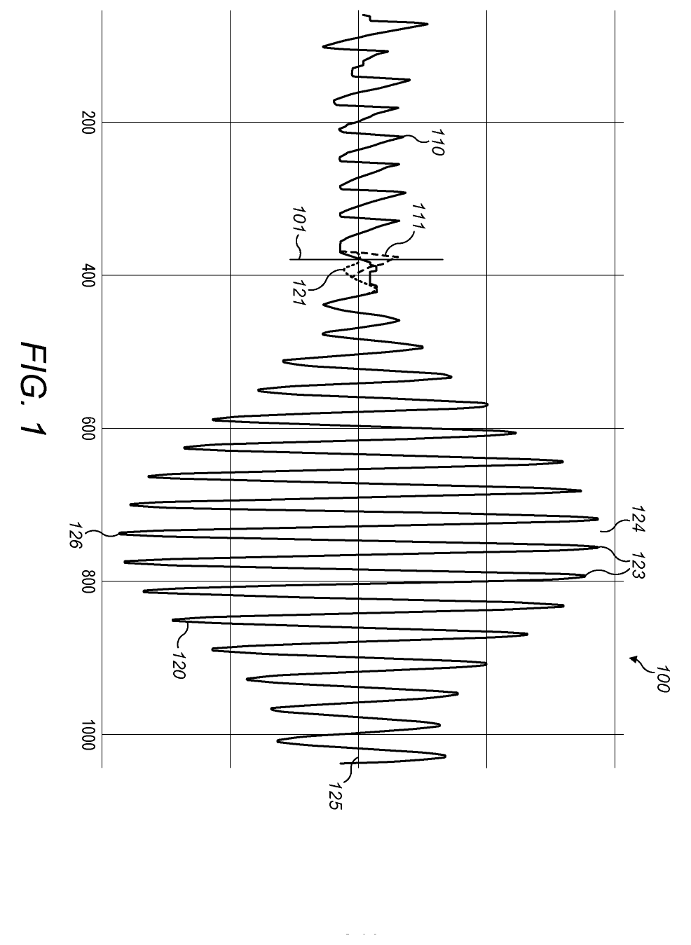

As mentioned above, FIG. 1 depicts an ultrasound signal 100, including a ringing signal 110 to the left of the time marker 101, and an echo signal 120 to the right of the time marker 101. Using the existing method, the time at which the echo signal 120 first reaches the receiver can only be inaccurately determined, as explained above. Therefore, the distance between a target and a receiver can only be inaccurately calculated using this method.

This disclosure relates to an alternative method of determining the distance of a target from a receiver, by determining the time 101 at which the echo signal 120 is first received by the receiver.

The signal 100 may be measured using any suitable known method. For example, an ultrasound wave or ultrasound signal may be transmitted towards an object or target. The wave may be transmitted by an ultrasonic transducer, such as an ultrasonic transmitter.

The target may reflect the ultrasound wave towards a receiver. The receiver may be configured to receive an echo signal 120 reflected by the target. The receiver may be an ultrasonic transducer, such as an ultrasonic receiver. The transmitter and the receiver may be separate components. Alternatively, the transmitter and the receiver may be part of the same component. For example, a system may comprise an ultrasonic transceiver that is configured to both transmit an ultrasound wave and to receive the reflected echo signal.

The signal 100 may be sampled using analogue to digital conversion, to produce a signal such as the one shown in FIG. 1.

The echo signal 120 may comprise a series of oscillations 123, as shown, for example, in FIG. 1. The boundary curve within which the echo signal 120 is contained is known as the “envelope”. In other words, the envelope of the echo signal 120 is a smooth curve that outlines the maxima and minima of the signal 120. The echo signal 120 may have an upper envelope and a lower envelope. The upper envelope may be a smooth curve defined by the maxima of the echo signal 120. The lower envelope may be a smooth curve defined by the minima of the echo signal 120. The echo signal 120 may therefore be contained between the upper envelope and the lower envelope.

The “front” of the upper envelope may be defined as the portion of the upper envelope between the time 101 at which the echo signal 120 is first received and the first maximum 124 of the upper envelope.

Likewise, the “front” of the lower envelope may be defined as the portion of the lower envelope between the time 101 at which the echo signal is first received and the first minimum 126 of the lower envelope.

The signal 100 may be sampled from the time at which the transmitter begins to transmit the ultrasound wave. The signal 100 may be sampled for any suitable time period. For example, the signal 100 may be sampled for a time period that includes the front of the envelope of the echo signal 120. For example, the signal 100 may be sampled for approximately 2ms. For example, the signal 100 may be sampled for approximately 1.5ms to 2.5ms.

It has been found that the envelope of the echo signal 120 closely corresponds to the shape of a sinusoidal waveform. In particular, the upper envelope of the echo signal 120, from the time 101 at which the echo signal 120 is first received to the first maximum 124 of the echo signal envelope, closely corresponds to the shape of a sinusoidal wave from a minimum to a maximum of the sinusoidal wave. In other words, the front of the upper envelope of the echo signal 120 closely corresponds to the shape of a sinusoidal wave from a minimum to a maximum of the sinusoidal wave, such as the portion of a sine wave from -90 degrees to 90 degrees. It will be appreciated that, while the following examples primarily discuss a sine wave from -90 degrees to 90 degrees, any sinusoidal wave having the same shape could be used. In other words, any portion of a sinusoidal waveform going from the minimum to the maximum of the sinusoidal wave could be used. For example, the sinusoidal wave could be a sine wave from -90 degrees to 90 degrees, a sine wave from 270 degrees to 450 degrees, a cosine wave from -180 degrees to 0 degrees, or a cosine wave from 180 degrees to 360 degrees. Any of these waves would be considered as a sinusoidal wave from a minimum to a maximum, and any other sinusoidal wave from a minimum to a maximum could be used.

The echo signal 120 may be analysed, to fit a sinusoidal wave, such as a sine wave, to the shape of the envelope of the echo signal 120.

For example, a sine wave 250 may be superimposed on the echo signal 120, and the sine wave 250 may be scaled so that the shape of the sine wave 250 closely aligns to the envelope of the echo signal 120. For example, the amplitude and/or the frequency of the sine wave 250 may be varied, and/or the sine wave 250 may be translated.

For example, a sine wave 250 from -90 degrees to 90 degrees may be superimposed on the echo signal 120. The maximum 251 of the sine wave 250, i.e. the point of the sine wave 250 corresponding to 90 degrees, may be aligned with the maximum 124 of the upper envelope of the echo signal 120.

The amplitude of the sine wave 250 may then be adjusted, so that the minimum 252 of the sine wave 250, i.e. the point of the sine wave 250 corresponding to -90 degrees, aligns with the zero axis 125 of the echo signal 120. In other words, the amplitude of the sine wave 250 may be adjusted so that the minimum 252 of the sine wave 250 aligns with the vertical midpoint 125 of the echo signal 120.

The frequency of the sine wave 250 may then be adjusted so that the shape of the sine wave 250 closely fits the shape of the front of the upper envelope of the echo signal 120.

It will be appreciated that the frequency could be varied before the amplitude is varied, or the amplitude could be varied before the frequency is varied. It will also be appreciated that multiple variations of the amplitude and frequency may be required, in order to fit the sine wave to the envelope of the echo signal. It will also be appreciated that, in some situations, it may be necessary to vary only the frequency or vary only the amplitude, if the amplitude or the frequency is already correct to fit the sine wave 250 to the front of the upper envelope of the echo signal 120.

It will also be appreciated that the sine wave 250 may need to be translated in any direction at any point during the fitting process.

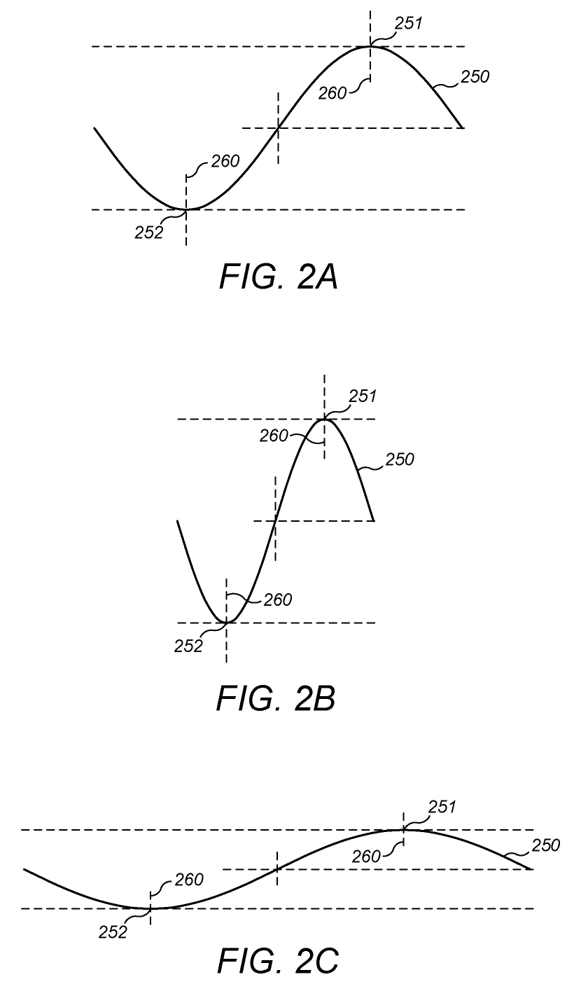

FIGS. 2A, 2B and 2C show a sine wave 250 being varied in amplitude and frequency. The sine wave of FIG. 2A, 2B and 2C is from -180 degrees to 180 degrees. In FIGS. 2A, 2B and 2C, the portion of the sine wave 250 that will be used for the fitting (i.e. the portion of the sine wave between -90 degrees and 90 degrees) is shown between the vertical dashed lines 260. However, since the portion of the sine wave 250 that is of interest in this situation is from -90 degrees to 90 degrees, it is envisioned that the manipulations of the shape of the sine wave could be performed on a sine wave that is only from -90 degrees to 90 degrees, or any sine wave including the section from -90 degrees to 90 degrees. It will also be appreciated that any other sinusoidal wave, in a portion from its minimum to its maximum, could instead be used, as explained above.

FIGS. 2A, 2B and 2C depict various modifications that can be made to the shape of the sine wave 250. If the sine wave 250 of FIG. 2A is taken to be the starting sine wave 250, then the sine wave 250 of FIG. 2B has had its amplitude increased and its frequency increased. In contrast, the sine wave 250 of FIG. 2C has had its amplitude decreased and its frequency decreased. Any suitable number of variations in amplitude, frequency and translation may be required in order to fit the sine wave 250 to the front of the upper envelope of the echo signal. The shape and/or position of the sine wave 250 may be adjusted until the sine wave 250 fits the front of the upper envelope of the echo signal. Whether the sine wave 250 fits the upper envelope of the echo signal may be determined by eye, or mathematically, using any suitable method. For example, the sine wave 250 may be considered to fit the front of the envelope of the echo signal when a predetermined number of peaks of the echo signal in the front of the envelope contact the sine wave 250. For example, the sine wave 250 may be considered to fit the front of the envelope of the echo signal when 3 peaks, 5 peaks, 7 peaks, or any suitable number of peaks of the echo signal in the front of the envelope contact the sine wave 250. The or each method of modification and/or fit, and the accuracy of the fit if the waveform to the echo signal may be determined by the waveform used.

The shape of the sine wave 250 may be adjusted in iterations. For example, small variations may be made to the shape of the sine wave 250. After each variation, the level of similarity between the sine wave and the front of the upper envelope of the echo signal 120 may be determined. The level of similarity may either be determined by eye, or mathematically. The iterations may continue until the maximum level of similarity is obtained.

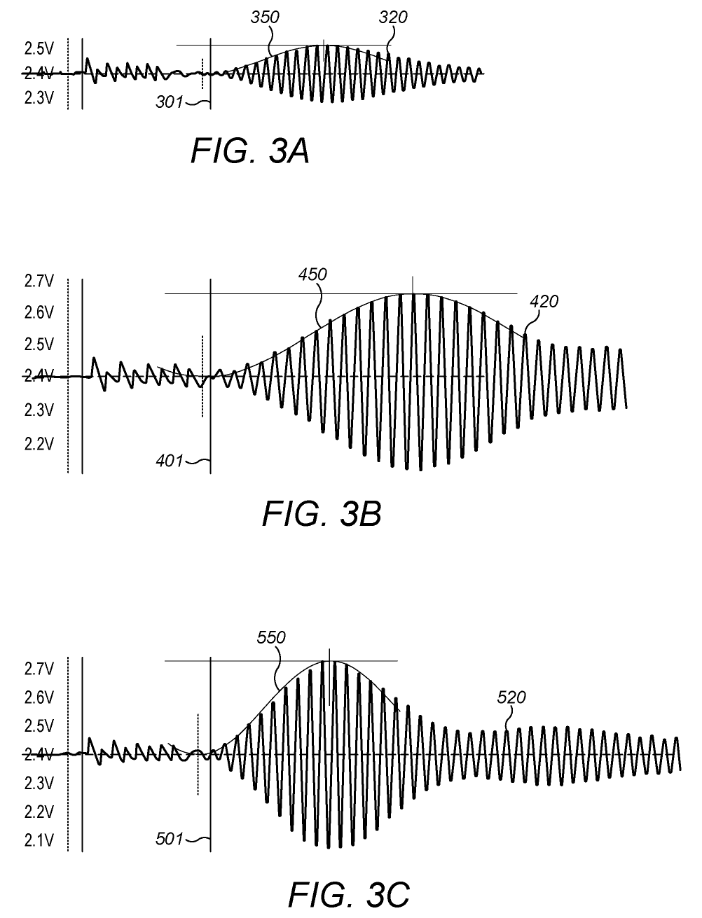

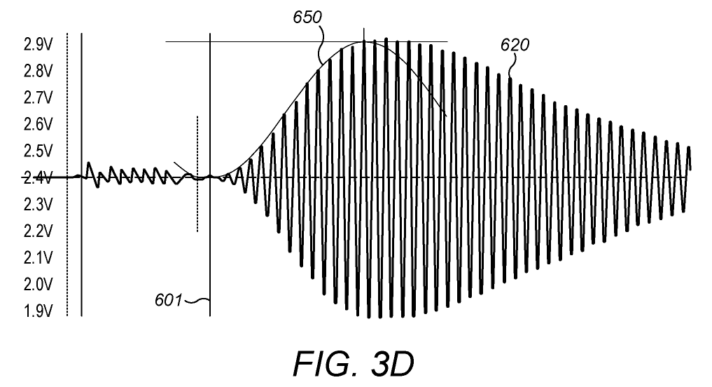

FIGS. 3A -3D show various echo signals 320, 420, 520, 620, with sinusoidal waves 350, 450, 550, 650 fitted to them in accordance with the above-described method. As shown, the echo signals 320, 420, 520, 620 all have different shapes. However, for each echo signal 320, 420, 520, 620, a sinusoidal wave such as a sine wave 350, 450, 550, 650 can be adjusted in frequency and amplitude so as to fit the shape of the front of the upper envelope of the echo signal 320, 420, 520, 620. In each case, the sine wave 350, 450, 550, 650 corresponds in shape to the front of the upper envelope of the echo signal 320, 420, 520, 620, from -90 degrees to 90 degrees of the sine wave 350, 450, 550, 650.

Therefore, once a sinusoidal wave 350, 450, 550, 650 has been fitted to the envelope of the echo signal 320, 420, 520, 620, the time-of-flight can be determined. That is, since the sinusoidal wave 350, 450, 550, 650 corresponds to the envelope of the echo signal 320, 420, 520, 620, the minimum of the sinusoidal wave 350, 450, 550, 650 (e.g. the -90 degree point of the sine wave 350, 450, 550, 650) corresponds with the time-of-arrival of the received ultrasound echo. In other words, once a sine wave 350, 450, 550, 650 has been fitted to the envelope of the echo signal 320, 420, 520, 620, the starting point in time (the time-of-arrival) 301, 401, 501, 601 can be determined from the -90 degree point of the sine wave 350, 450, 550, 650.

The time 301, 401, 501, 601 at which the -90 degree point of the sine wave 350, 450, 550, 650 fits the envelope of the echo signal 320, 420, 520, 620 is the time-of-arrival of the received ultrasound echo. This time-of-arrival 301, 401, 501, 601 can be used to calculate the time-of-flight of the signal. The time-of-flight is directly proportional to the distance from the target to the receiver. Therefore, by determining the time at which the -90 degree point of the sine wave 350, 450, 550, 650 fits the envelope of the echo signal 320, 420, 520, 620, the distance between the target and the receiver can be determined. It will be appreciated that, if another sinusoidal wave has been fitted to the echo signal 320, 420, 520, 620 from the minimum to the maximum of the sinusoidal wave, then the minimum of the sinusoidal wave can be used to calculate time-of-flight of the signal, and hence the distance between the target and the receiver.

Determining a distance using a sinusoidal wave according to the above method may be advantageous, as it allows the distance to be determined using ultrasound to a high degree of accuracy.

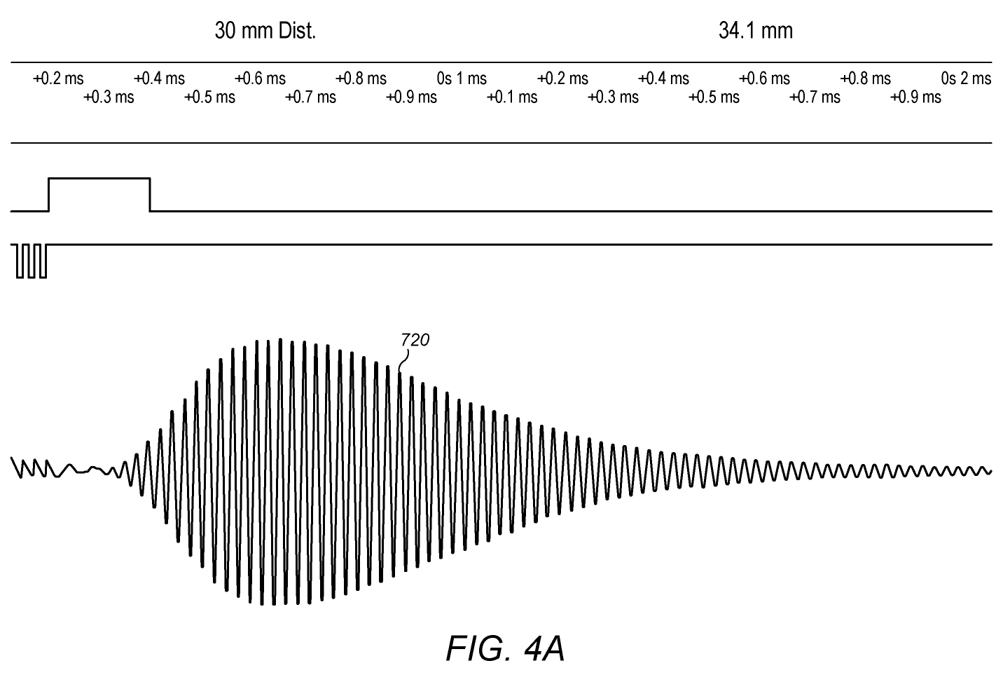

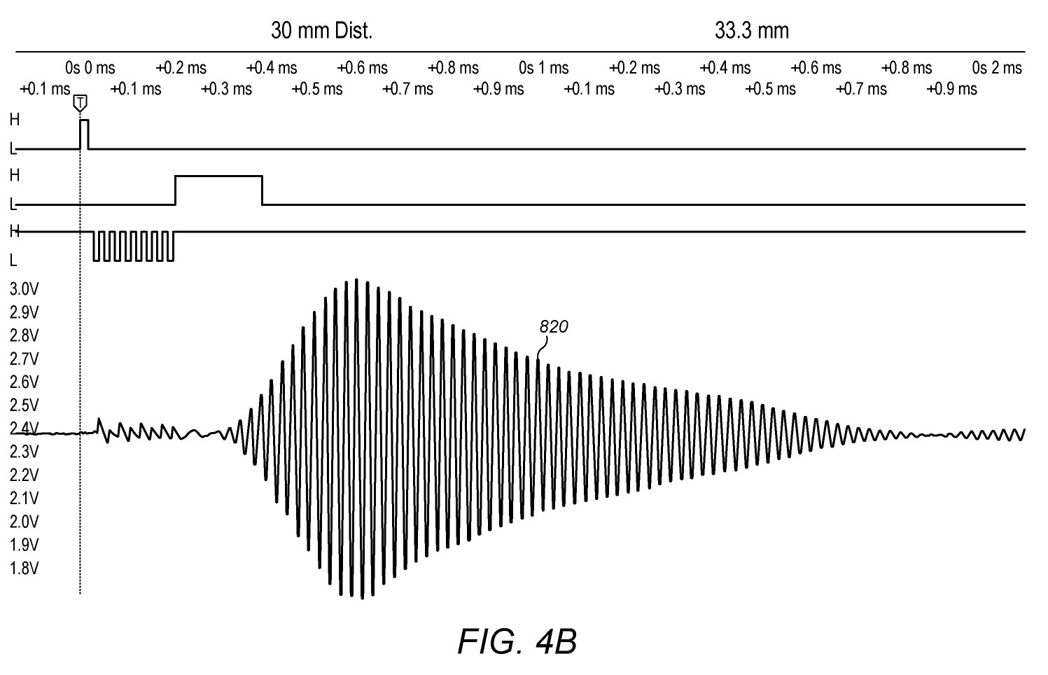

The high accuracy may be maintained, even if the target of the object varies. For example, FIGS. 4A and 4B show echo signals 720, 820 for two objects, placed at exactly the same distance from a receiver, where the two objects have different curvatures from one another. The object of FIG. 4A is 30 mm from the receiver, and its diameter is 33 mm. The object of FIG. 4B is 30 mm from the receiver, and its diameter is 110 mm. As shown by comparison of FIG. 4A with FIG. 4B, the shape of the echo signal 720, 820, and consequently the shape of the envelope of the echo signal, is completely different for the two different shaped objects. As a result of this different shape of echo signal 720, 820, when the prior art “threshold” method is used to calculate the distance to the targets, the prior art method calculates distances from the receiver of 34.1 mm for one target, and 33.3 mm for the other target. This is because, due to the different shapes of the echo signals 720, 820, the echo signal 720 from the object in FIG. 4A would cross the threshold value later than the echo signal 820 from the object in FIG. 4B. For example, depending on the threshold value, the echo signal 720 from one object could have an amplitude that crosses the threshold value at the 5^{th} wave, whereas the 4^{th} wave of the echo signal from the other object could have an amplitude that crosses the threshold value. The difference in shape between echo signals from differently shaped objects therefore results in a large inaccuracy in the calculated distance. For example, the error margin for the known threshold method of calculation may be ± half the ultrasound wavelength. For a 40 kHz sound wave in air (e.g. a classic low-cost transducer), the wavelength is approximately 4 mm. Therefore, the error margin for the known threshold method may be up to 4mm. By way of example, as shown in FIGS. 4A and 4B, the threshold method calculated the distance to the first object to be 34.1 mm and the distance to the second object to be 33.3 mm. Therefore, there is a 0.8 mmdifference in calculation using the known method of calculation, when the two objects are the same distance from the receiver. Therefore, the threshold method is generally relatively inaccurate.

However, if a sinusoidal wave from its minimum to its maximum is superimposed on each of the echo signals 720, 820, then the starting point 701, 801 of the sinusoidal waves (e.g. -90 degrees of the sine waves) is the same for both signals 720, 820.

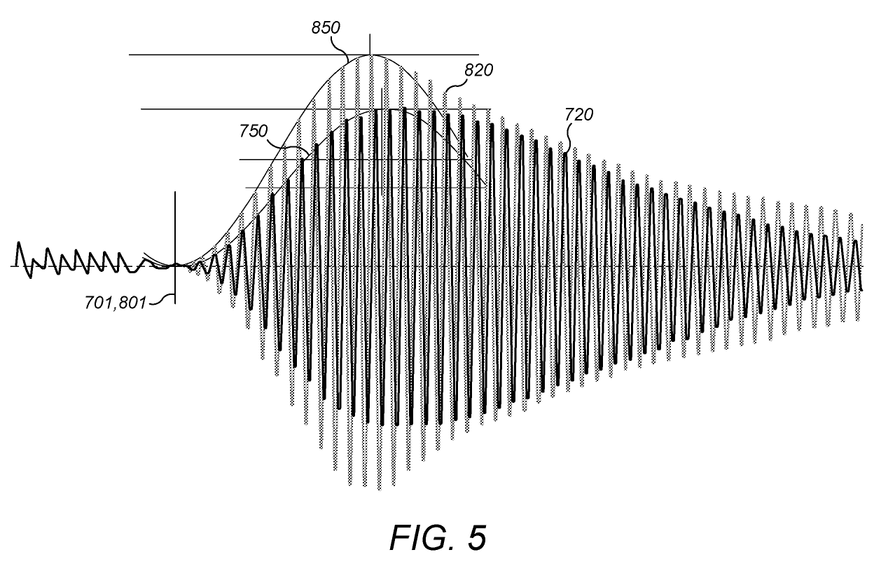

FIG. 5 shows the two echo signals 720, 820 of FIGS. 4A and FIG. 4B superimposed onto one another. A sine wave 750, 850 has been fitted onto the front of the upper envelope of each of the echo signals 720, 820. As shown in FIG. 5, in order for the sine waves 750, 850 to fit the echo signals 720, 820, one of the sine waves 750 must have a smaller amplitude and smaller frequency than the other sine wave 850. In each case, an adjustment step is carried out, in which the amplitude, frequency and/or translation of the sine wave 750, 850 is adjusted/carried out as necessary, as explained above, until the sine wave 750, 850 fits the shape of the echo signal 720, 820. This results in sine waves 750, 850 that have different properties (amplitude and frequency) from one another, due to the different shapes of the envelopes of the echo signals 720, 820.

However, as shown in FIG. 5, when the sine wave 750, 850 is fitted onto the front of the upper envelope of each of the echo signals 720, 820, the starting point 701, 801 of each of the sine waves 750, 850 (i.e. the -90 degree point of each of the sine waves 750, 850) is at the same point. This is because each of the two targets are at the same distance from the receiver. In other words, even though the shape of the object or target affects the shape of the envelope of the echo signal 720, 820, when a sine wave 750, 850 is fitted to the front of the envelope of the echo signal 720, 820, the sine wave 750, 850 will have the same starting point 701, 801 (i.e. the -90 degree part of the sine wave). This means that the time-of-arrival, and hence the time-of-flight, determined based on the starting point 701, 801 of the sine waves 750, 850, will be the same for both echo signals 720, 820.

Therefore, the method according to certain implementations is advantageous, because the distance to a target can be accurately determined, irrespective of the shape of the target.

The above example is given in relation to a sine wave from -90 degrees to 90 degrees being fitted to the front of the upper envelope of the echo signal. As explained above, any sinusoidal waveform from its minimum to its maximum could be fitted to the front of the upper envelope of the echo signal. However, it will be appreciated that, additionally or alternatively, a sinusoidal waveform from its maximum to its minimum could be fitted to the front of the lower envelope of the echo signal. For example, a sine wave from 90 degrees to 270 degrees could be fitted onto the front of the lower envelope of the echo signal. In this case, any of the above variations to the amplitude, frequency or translation of the sinusoidal wave could be made. However, in this case, the minimum of the sinusoidal wave, e.g. the point of a sine wave corresponding to 270 degrees, may be aligned with the minimum of the echo signal lower envelope.

The amplitude of the sinusoidal wave may then be adjusted, so that the maximum of the sinusoidal wave, e.g. the point of the sine wave corresponding to 90 degrees, aligns with the zero axis of the echo signal. In other words, the amplitude of the sinusoidal wave may be adjusted so that the maximum of the sinusoidal wave aligns with the vertical midpoint of the echo signal.

Therefore, either the front of the upper envelope, or the front of the lower envelope, or both, may be used in the method. In the event that the upper envelope and the lower envelope are both used in the method, either a sinusoidal wave from its minimum to its maximum, or a sine wave from its maximum to its minimum, or both, may be fitted to the envelopes. For example, a sine wave from -90 degrees to 90 degrees may be fitted to the front of the upper envelope, and a sine wave from 90 degrees to 270 degrees may be fitted to the front of the lower envelope. By fitting two sinusoidal waves to the echo signal, the accuracy of the method may be improved, by providing confirmation of the start points of each of the sinusoidal waves. Alternatively, before a sinusoidal wave is fitted to any envelope, the lower envelope may be mirrored about the zero axis, by making all negative values of the echo signal positive. This will provide a single envelope having twice as many half waves forming the shape of the envelope. A sine wave from -90 degrees to 90 degrees may then be fitted to the front of the resulting upper envelope, in accordance with the above method. By mirroring the lower part of the echo signal to provide twice as many positive values in the upper envelope, the accuracy of the measurement may be improved, because the sine wave may more accurately fit the curve of the envelope. Therefore, it may be advantageous for both the upper and the lower envelope of the echo signal to be used in the method, in order to improve the accuracy of the measurement. While the above description relates to mirroring the lower envelope, it will be appreciated that the upper envelope could alternatively be mirrored, and a sine wave from 90 degrees to 270 degrees could instead be used to fit the resulting lower envelope.

Alternatively, in some versions, it may be advantageous to use only one of the upper and lower envelopes, for simplicity and speed of calculation.

The above-described method may be used for measuring distance in a variety of different fields. For example, the method may be used in a printing system. The target may be a component of the printing system. For example, the component may be a ribbon, for example an outer portion of a spool of ribbon, in a printing apparatus. Therefore, the above-described method may be used to determine the radius or diameter of a spool of ribbon in a printing apparatus. Alternatively, the target may be another component of a printing system, such as a printhead or a surface to be printed. For example, the above-described method may be used to determine the distance between a printhead and a surface to be printed.

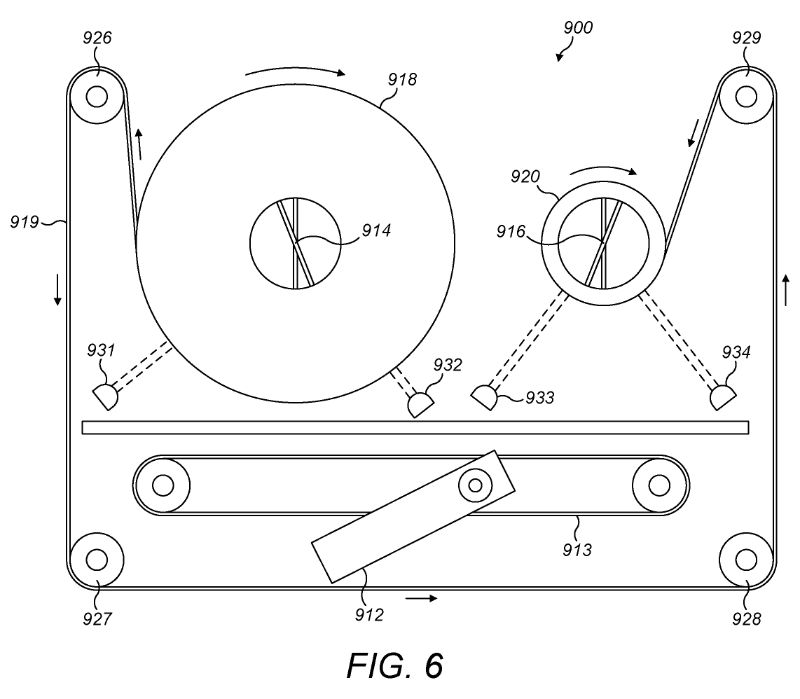

FIG. 6 shows some of the components of a printing apparatus 900. The printing apparatus 900 may include a printhead 912 and a pair of spool supports 914, 916 upon which spools of ribbon 918, 920 may be mounted. The spool supports 914, 916 may be rotatable to transfer ribbon 919 from one spool of ribbon 918 to the other 920, past the printhead 912 in a ribbon path. For example, the spool supports 914, 916 may be rotatable to transfer ribbon 919 from a supply spool 918 to a take up spool 920. The spool supports 914, 916 may be rotatable in two directions, i.e. in a forward direction and a reverse direction. The ribbon path may include one or more guide rollers 926, 927, 928, 929, which may guide the ribbon along its path. It will be appreciated that, depending on the desired shape of the ribbon path and the relative arrangement of the spool supports 918, 920 and printhead 912, the printing apparatus 900 may contain no guide rollers 926, 927, 928, 929. The printing apparatus 900 may comprise a mechanism 913 that is configured to move the printhead 912 along the surface of a substrate, and/or to move the printhead 912 closer to and/or further from the surface of the substrate.

The printing apparatus 900 may also comprise one or more ultrasonic transducers 931, 932, 933, 934. At least one of the ultrasonic transducers 931, 932, 933, 934 may be configured to transmit an ultrasound wave towards the centre of one of the spools of ribbon 918, 920. For example, at least one of the ultrasonic transducers 931, 932, 933, 934 may be configured to direct an ultrasound wave towards one of the spool supports 914, 916. When a spool of ribbon 928, 930 is positioned on the spool support 914, 916, the ultrasound wave may therefore reflect from the outermost surface of the ribbon 919 of the spool 918, 920. Therefore, the ribbon 919 of the supply spool 918 and/or the ribbon 919 of the take up spool 920 may act as the object or target described above. One or more of the ultrasonic transducers 931, 932, 933, 934 may be an ultrasonic transmitter 931, 934 that is configured to transmit an ultrasound wave. The illustrated printing apparatus comprises four ultrasonic transducers 931, 932, 933, 934, two of which are ultrasonic transmitters 931, 934. However, as explained further below, it is envisioned that the printing apparatus 900 could comprise any suitable number of ultrasonic transducers 931, 932, 933, 934.

Each target, i.e. the ribbon 919 of the supply spool 918 and/or the ribbon 919 of the take up spool 920 may reflect the ultrasound wave towards an ultrasonic transducer 931, 932, 933, 934, such as an ultrasonic receiver 932, 933. The one or more ultrasonic receivers 932, 933 may be configured to receive the ultrasound wave reflected by the ribbon 919. Therefore, the printing apparatus 900 may be configured such that the ultrasound wave is transmitted from an ultrasonic transmitter 931, 934, reflected from a surface of the ribbon 919 on spool support 914, 916, and then received by an ultrasonic receiver 932, 933.

As shown in FIG. 6, the printing apparatus 900 may comprise ultrasonic transmitters 931, 934 and ultrasonic receivers 932, 933 that are separate components. Each ultrasonic transmitter 931, 934 and its corresponding ultrasonic receiver 932, 933 may be positioned any appropriate distance from one another, provided that the ultrasonic receiver 932, 933 is configured to detect the wave transmitted from a corresponding ultrasonic transmitter 931, 934 and reflected by the ribbon 919. An ultrasonic transmitter 931, 934 and its corresponding ultrasonic receiver 932, 933 may be positioned adjacent to each other. Alternatively, the printing apparatus 900 may comprise ultrasonic transmitters 931, 934 and ultrasonic receivers 932, 933 that are part of the same component. For example, the printing apparatus 900 may comprise an ultrasonic transceiver that is configured to both transmit an ultrasound wave and to receive the reflected echo signal. In this way, the ultrasonic transceiver may act as both the transmitter and the receiver. Alternatively, an ultrasonic transmitter 931, 934 and an ultrasonic receiver 932, 933 may be integrated into a single unit.

The illustrated printing apparatus 900 comprises two ultrasonic transmitters 931, 934: one supply spool transmitter 931 and one take up spool transmitter 934. Likewise, the printing apparatus 900 comprises two ultrasonic receivers: one supply spool receiver 932 and one take up spool receiver 933. However, it will be appreciated that the printing apparatus 900 could include one or more ultrasonic transducers 931, 932, 933, 934 directed towards only one of the spools of ribbon 918, 920, i.e. either a supply spool transducer or a take up spool transducer. The printing apparatus 900 may comprise one or more ultrasonic transducers 931, 932, 933, 934 for each of the spools of ribbon 918, 920. Alternatively, the printing apparatus 900 may comprise a single ultrasonic transducer that is configured to operate on both the supply spool 918 and the take up spool 920.

As explained above, the printing apparatus 900 may be configured such that an ultrasound wave is transmitted from an ultrasonic transmitter 931, 934, reflected from a surface of the ribbon 919 on spool support 914, 916, and then received by an ultrasonic receiver 932, 933. This will cause each ultrasonic receiver 932, 933 to receive an echo signal 120, 320, 420, 520, 620, 720, 820 reflected from the surface of the ribbon 919.

A processor or controller, all or part of which may be part of the printing apparatus 900 or may be positioned externally, may receive the echo signal 120, 320, 420, 520, 620, 720, 820. For example, one or more ultrasonic receivers 932, 933 may be configured to transmit an echo signal 120, 320, 420, 520, 620, 720, 820 to the processor. The processor may then be configured to analyse the echo signal 120, 320, 420, 520, 620, 720, 820 using the above-described method, in order to determine the time-of-flight of the echo signal 120, 320, 420, 520, 620, 720, 820. In other words, a sinusoidal wave 250, 350, 450, 550, 650, 750, 850 may be fitted to the front of an envelope of the echo signal 120, 320, 420, 520, 620, 720, 820. The sinusoidal wave 250, 350, 450, 550, 650, 750, 850 can be used to determine the time-of-arrival 101, 301, 401, 501, 601, 701, 801 of the echo signal 120, 320, 420, 520, 620, 720, 820, as explained above. The time-of-arrival 101, 301, 401, 501, 601, 701, 801 of the echo signal 120, 320, 420, 520, 620, 720, 820 can be used to calculate the time-of-flight of the signal. The time-of-flight is directly proportional to the distance from the target to the receiver, i.e. the distance between the ribbon 919 on the spool 918, 920 and the ultrasonic receiver 932, 933. Therefore, by determining the time at which the minimum of the sinusoidal wave 350, 450, 550, 650 fits the front of the upper envelope of the echo signal 320, 420, 520, 620, the distance between the ultrasonic receiver 932, 933 and the ribbon 919 at the outermost portion of the spool 918, 920 can be determined. The processor or controller may control operation of one or more of the ultrasonic transducers 931, 932, 933, 934 and/or receive information relating to one or more of the ultrasonic transducers 931, 932, 933, 934. The processor or controller may control, know and/or receive information relating to the time of transmission of the or each ultrasound signal by the or each ultrasonic transmitter 931, 934.

The distance from the spool support 914, 916 to the ultrasonic receiver 932, 933 is a fixed, known value. According to the above method, the distance from the target surface (e.g. the surface of the ribbon 919 on the spool 918, 920) to the ultrasonic receiver 932, 933 may be calculated. By subtracting this calculated distance from the known distance from the spool support 914, 916 to the ultrasonic receiver 932, 933, the radius of the spool of ribbon 918, 920 can be determined. This radius may therefore be used to determine the diameter of the spool of ribbon 918, 920. It is envisioned that either the radius or the diameter of the spool of ribbon 918, 920 could be used in a calibration process that is performed before printing with the printing apparatus 900.

Therefore, a printing system including the printing apparatus 900 and a processor may be used to determine the diameter of a spool of ribbon 918, 920 during a calibration process. As explained above, the processor may be external to the printing apparatus 900, or the printing apparatus 900 may comprise the processor. As explained above, the method allows a much more accurate determination of distance (e.g. diameter). The method also allows the diameters to be calculated very quickly. This improvement in the speed of measuring one or both of the ribbon spool diameters greatly improves the overall speed of the calibration process, from the point when the user closes the cassette to the point when the printer can make the first print, since measuring the ribbon spool diameters is currently one of the slowest stages of the calibration process. Therefore, the method and printing system may improve the efficiency of the printing apparatus 900, by reducing the time used during the calibration processes. Because certain implementations of the present invention do not require movement of the ribbon spools 918, 920, the ribbon diameter measurement is almost instantaneous. Furthermore, the ribbon diameter measurement may be performed independent of ribbon movement and thus can be performed simultaneously with other calibration steps, such as the tension calibration, the thermal printhead (TPH) calibration and/or the carriage calibration. Therefore, the efficiency of the printing apparatus 900 may be further improved.

When used in this specification and claims, the terms "comprises" and "comprising" and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A printing system comprising:
a printing apparatus;
one or more ultrasonic transmitters configured to transmit an ultrasound signal towards a component of the printing system;
an ultrasonic receiver configured to receive an echo signal corresponding to the ultrasound signal reflected from the component; and
a processor configured to:
fit a part of a sinusoidal wave, from a minimum to a maximum of the sinusoidal wave, to a front of an upper envelope of the echo signal and/or fit a part of a sinusoidal wave, from a maximum to a minimum of the sinusoidal wave, to a front of a lower envelope of the echo signal;
determine a time-of-arrival corresponding to the minimum of the sinusoidal wave fitted to the upper envelope and/or the maximum of the sinusoidal wave fitted to the lower envelope;
determine a time-of-flight of the ultrasound signal; and
calculate the distance between the ultrasonic receiver and the component, based on the time-of-flight and the speed of the ultrasound signal.

2. The printing system according to claim 1, wherein the printing apparatus comprises the processor.

3. The printing system according to claim 1, wherein the printing apparatus comprises an ultrasonic transceiver configured to both transmit and receive the ultrasound signal.

4. The printing system according to claim 1, wherein the component is a ribbon positioned on a spool support of the printing apparatus.

5. The printing system according to claim 4, wherein at least one ultrasonic transmitter is configured to transmit an ultrasound signal towards a supply spool support of the printing apparatus, and the processor is configured to calculate the diameter or radius of a supply spool of ribbon.

6. The printing system according to claim 4, wherein at least one ultrasonic transmitter is configured to transmit an ultrasound signal towards a take up spool support of the printing apparatus, and the processor is configured to calculate the diameter or radius of a take up spool of ribbon.

7. The printing system according to claim 1, wherein the processor is configured to fit the sinusoidal wave to the echo signal by:
adjusting one or more of the amplitude and frequency of the sinusoidal wave; and/or
translation of the sinusoidal wave.

8. The printing system according to claim 7, wherein the processor is configured to fit the sinusoidal wave to the echo signal by aligning the maximum of the sinusoidal wave with a maximum of the upper envelope of the echo signal and/or aligning the minimum of the sinusoidal wave with a minimum of the lower envelope of the echo signal.

9. The printing system according to claim 7, wherein the processor is configured to fit the sinusoidal wave to the echo signal by adjusting the amplitude of the sinusoidal wave so that the minimum of the sinusoidal wave fitted to the upper envelope and/or the maximum of the sinusoidal wave fitted to the lower envelope aligns with a vertical midpoint of the echo signal.

10. The printing system according to claim 7, wherein the processor is configured to fit the sinusoidal wave to the echo signal by adjusting the frequency of the sinusoidal wave so that the shape of the sinusoidal wave closely fits the shape of the front of the upper and/or lower envelope of the echo signal.

11. The printing system according to claim 1, wherein the processor is configured to fit the sinusoidal wave to the echo signal in a plurality of iterations.

12. The printing system according to claim 1, wherein the processor is configured to measure a degree of similarity between the shape of the sinusoidal wave and the shape of the upper envelope and/or lower envelope of the echo signal.

13. A method of calculating the distance between an ultrasound receiver and a component of a printing system, comprising:
receiving an echo signal corresponding to an ultrasound signal reflected from the component and received by the receiver;
fitting a part of a sinusoidal wave, from a minimum to a maximum of the sinusoidal wave, to a front of an upper envelope of the echo signal and/or fitting a part of a sinusoidal wave, from a maximum to a minimum of the sinusoidal wave, to a front of a lower envelope of the echo signal;
determining a time-of-arrival corresponding to the minimum of the sinusoidal wave fitted to the upper envelope and/or the maximum of the sinusoidal wave fitted to the lower envelope;
determining a time-of-flight of the ultrasound signal; and
calculating the distance between the receiver and the component, based on the time-of-flight and the speed of the ultrasound signal.

14. The method according to claim 13, further comprising the step of transmitting the ultrasound signal towards the component using an ultrasonic transmitter.

15. The method according to claim 13, further comprising the step of receiving the echo signal using an ultrasonic receiver.

16. The method according to claim 15, wherein the ultrasonic receiver is an ultrasonic transceiver.

17. The method according to claim 13, wherein the step of fitting the sinusoidal wave comprises:
adjusting one or more of the amplitude and frequency of the sinusoidal wave; and/or
translation of the sinusoidal wave.

18. The method according to claim 17, wherein the step of fitting the sinusoidal wave comprises aligning the maximum of the sinusoidal wave with a maximum of the upper envelope of the echo signal and/or aligning the minimum of the sinusoidal wave with a minimum of the lower envelope of the echo signal.

19. The method according to claim 17, wherein the step of fitting the sinusoidal wave comprises adjusting the amplitude of the sinusoidal wave so that the minimum of the sinusoidal wave fitted to the upper envelope and/or the maximum of the sinusoidal wave fitted to the lower envelope aligns with a vertical midpoint of the echo signal.

20. The method according to claim 17, wherein the step of fitting the sinusoidal wave comprises adjusting the frequency of the sinusoidal wave so that the shape of the sinusoidal wave closely fits the shape of the front of the upper and/or lower envelope of the echo signal.

21. The method according to claim 13, wherein the sinusoidal wave is fitted to the echo signal in a plurality of iterations.

22. The method according to claim 13, further comprising measuring a degree of similarity between the shape of the sinusoidal wave and the shape of the front of the upper envelope and/or lower envelope of the echo signal.

23. The method according to claim 13, wherein the component is a ribbon.
